(19) United States
(12) Patent Application Publication
(10) Pub. No.: US 2024/0426782 A1
(43) Pub. Date: Dec. 26, 2024

(54) ULTRASONIC QUALITY SENSOR DETECTS UREA CONCENTRATION WITH ONE PULSE CYCLE TIME TO COVER FULL DEF CONCENTRATION

(71) Applicant: ShenZhen KEWEI Neo_Tech Co.,Ltd., Shenzhen (CN)

(72) Inventors: Zhenwu Guo, Shenzhen (CN); Xiaoqing Chen, Shenzhen (CN)

(73) Assignee: ShenZhen KEWEI Neo_Tech Co.,Ltd., Shenzhen (CN)

(21) Appl. No.: 18/750,794

(22) Filed: Jun. 21, 2024

(30) Foreign Application Priority Data
Jun. 25, 2023 (CN) 202310757264 .0

(51) Int. Cl. G01N 29/024; G01N 29/22; G01N 29/24; G01N 29/30; G01N 29/34

(52) U.S. Cl. CPC G01N 29/024; G01N 29/222; G01N 29/245; G01N 29/30; G01N 29/343

(57) ABSTRACT

The ultrasonic quality sensor includes a probe assembly, a control module, an ultrasonic probe base, a probe filter, a temperature sensor, and a probe top cover; The probe assembly consists of a transmitting and a receiving transducer to form a face-to-face layout and the ultrasonic flight distance h, h≤(V0*V50)*T0/(V50−V0), where T0 is the pulse width, V0 is the ultrasonic speed at 4° C. in water, V50 is the ultrasonic speed at 50% urea and 70° C. Sampling timing tb∈[t0, t0+C], where C=(N+1)*T0, t0=h/V0, N is the number of ultrasonic actuating pulses. tr and td are first rising edge trigger timing and first falling edge trigger timing; As long as td−tr exceeds a certain percentage of T0, the chip can catch timing tf after tb of wave rising edge crosses zero. The cylindrical ring has small holes to carry away bubbles during high-temperature stages.

### CROSS-REFERENCE TO RELATED APPLICATIONS

The application claims priority to Chinese patent application No. 202310757264.0, filed on Jun. 25, 2023, the entire contents of which are incorporated herein by reference.

### TECHNICAL FIELD

The invention relates to the commercial vehicle exhaust gas treatment SCR system, in particular to an ultrasonic quality sensor for the SCR system, and more specifically to an ultrasonic urea concentration detection technology for quality sensor to the SCR system.

### BACKGROUND

SCR system uses 32.5% urea concentration solution to spray into the automobile exhaust, using the residual temperature of the exhaust gas, urea and NOx in the exhaust gas chemical reaction, reaction products for nitrogen and water molecules, to achieve the harmful NOx in the exhaust gas into harmless nitrogen and water molecules.

With the tightening of national environmental regulations, the SCR system needs to conduct dynamic detection of urea concentration in the national sixth stage and the later National seventh standard stage, and the usual urea concentration detection technology adopts ultrasonic quality sensor detection.

The ultrasonic quality sensor is composed of an ultrasonic wave probe in front of it, and a back-end control module behind it. The back-end control module can be divided into electronic circuit hardware and communication, control strategy and other software components.

The ultrasonic probe and its back-end electronic circuit hardware are the basis of ultrasonic quality sensors. The basic principle of the detection of concentration is that the flight speed of the ultrasonic wave in the solution of different concentrations is different, as long as we can obtain the flight time of the ultrasonic wave in the solution Δt through the design of the electronic circuit, in the case of the same flight distance, Δt can be regarded as the concentration. The technology used to capture time-of-flight Δt is called TOF (Time Of Fly), and it already has mature TOF integrated circuit technology in commercial environments. The quality sensor is made of professional TOF chip, and its electronic circuit and front-end probe are designed around the chip.

The current probe technology is designed with a single-send, single-receive ultrasonic probe structure in order to address the size and cost constraints. This means that an ultrasonic probe serves as both the transmitter and receiver of ultrasonic waves. While this design offers advantages in terms of size and cost, it also presents two significant drawbacks. Firstly, ultrasonic probes are unable to avoid aftershocks, even when efforts are made to distance the reflector from the probe. Secondly, as the flight distance of ultrasonic waves increases in urea, there is a corresponding increase in signal attenuation.

The current software strategy for quality sensors in signal processing relies on a large number of laboratory data acquisition methods, such as batch acquisition of data in the database to establish a two-dimensional relational table or using batch data in the database to seek the best fitting function. Whether it is a two-dimensional relational table related to the database or the solution of the fitting function, its essence is to obtain the TOF time Δt for application scenarios, such as different probes corresponding to different concentrations and temperatures. In these application scenarios, the most common problem encountered by the software strategy is that at high temperatures, ultrasonic signals cause collapse in TOF time Δt and lead to counter-logical concentration measurement results, such as negative concentrations or values exceeding 100%. This is mainly due to urea solution precipitating of carbon dioxide and oxygen at high temperatures because of decreased solubility of dissolved carbon dioxide and oxygen. Additionally, periodic sound pressure fluctuations from ultrasonic waves also cause urea liquid vaporization. The combination of these factors intensifies bubble formation mechanisms at high temperatures, resulting in severe attenuation of emitted and returned ultrasonic waves. As a result, probe signal strength may be equivalent to background noise from electronic circuits and hardware, cannot correctly distinguish the first wave of returned ultrasonic waves.

Aiming at the defects of the probe design and its supporting software strategy, the invented embodiment proposes a ultrasonic quality sensor detects urea concentration within one pulse cycle time to cover the full DEF concentration.

### SUMMARY

The main technical problem solved by the present invented embodiment is to provide an ultrasonic quality sensing technology based on the full concentration coverage within one ultrasonic pulse cycle time, specifically utilized as the follows:

An ultrasonic quality sensor detects urea concentration with one pulse cycle time to cover full DEF concentration, including probe assembly, control module, ultrasonic probe base, probe filter, temperature sensor, probe top cover and control module.

The probe assembly is the main mechanism of the ultrasonic probe for quality detection, which is geometrically arranged face to face by two ultrasonic transducers.

Specifically, two transducers, one is the transmitting transducer and the other is the receiving transducer, the transmitting transducer and the receiving transducer constitute the concentration detection cavity of the quality sensor.

The concentration detection cavity is a hollowed-out cylindrical structure formed by removing the central axis of a regular quadrangular cylinder. The ends of the cavity are inserted with a receiving transducer and a transmitting transducer respectively. A cylindrical ring, equipped with multiple forward water inlet holes, is placed closed to the sidewall of the cavity in between the two transducers, and also features a vertical liquid outlet tank.

The front end position of the ultrasonic probe base is used to house the probe assembly.

Specifically, there is a “T” shaped double column space on the front end of the ultrasonic probe base. In the “T” shaped double column space, one is a forward column space, and the other is vertical to the forward column space. The column space can be either cylindrical or square cylindrical.

The forward column space is connected to the forward water inlet holes of the cylinder ring at one end, and the other end serves as the probe inlet. The transverse column space is equipped with the probe assembly, and the liquid outlet tank of the cylinder ring is connected to the probe top cover through an outlet groove sealing plate. The probe liquid inlet is equipped with a filter sealing ring with sealing effect and a probe filter with filtering effect. The tail end of the probe top cover functions as a probe outlet, which is sealed in the SCR system through a sealing ring, and connects to form an enclosed space with the suction tube and top cover outlet cavity.

Preferably, the area size of the vertical liquid outlet groove of the cylindrical ring should be significantly larger than the combined areas of the water inlet holes. The forward water inlet holes represent the narrowest section within the entire cavity, extending from the probe inlet to the extraction pipe of the SCR system. it is important that urea liquid flows into these water inlet holes at a rapid rate.

Preferably, the liquid outlet direction of the cylindrical ring is aligned with the transmitting transducer and the ultrasonic transmitting surface and the ultrasonic receiving surface receiving the transducer; the high flow liquid will wash the bubbles generated at high temperature and reduce the amount of bubble aggregation.

Specifically, the assembly relationship between the cylindrical ring and the two transducers makes the position between the ultrasonic transmitting surface of the transmitting transducer and the ultrasonic receiving surface is coaxial and exactly face to face, and the distance between the ultrasonic transmitting surface and the ultrasonic receiving surface is h.

Preferably, the cylindrical ring is made of metal stainless steel, whose length L is less than or equal to h+2H mm; the two ends of the cylindrical ring contact with the stop limit surface of the transmitting transducer and the stop limit surface of the receiving transducer, the two end surfaces of the cylindrical ring and the axis of the cylindrical ring are strictly perpendicular, and the end surface is high light surface; H is the distance from the ultrasonic transmitting surface to its stop limit surface or the distance from the ultrasonic receiving surface to its stop limit surface.

The control module includes a power module, communication module, drive and measurement module, AD/DA module, calibration and decision module and main control module.

The power supply module provides power to the control module.

The communication module is based on the SAE1939 communication protocol to interconnect the host system and the quality sensor.

Specifically, the control module is equipped with a temperature sensor and electronic circuitry to accurately measure the urea temperature. The temperature data obtained from measuring the urea solution is then utilized in the calibration and decision module to build the function or database.

preferably, the core chip of the drive and measurement module selects MS1022 or its iterative updated version chip, such as MS 1030; the selected chip has dual channel independent operation function, dual channel is identified as transmitting channel and measurement channel.

The main control module and the driving and measuring module work together to generate a fixed frequency F0 pulse square wave, which is then applied to the transducer plate of the transmitting transducer. The periodic pulse signal stimulates mechanical vibration of the transducer plate. Simultaneously, when the excitation signal is generated and applied to the transducer, the transmitting channel initiates system timing. The transmitting transducer generates mechanical vibration and emits ultrasonic waves outward, which travel a fixed flight distance h to reach the receiving transducer. MS1022 or MS1030, at a specified time determined by program control instructions from the main control module, free point time tb opens the measurement channel and starts timing. The measurement channel performs single-point sampling based on program-controlled amplitude of measured signals or continuous multi-point sampling. The specific sampling process compares with program-set thresholds to trigger system timing, which is then read at specified time points and stored in corresponding memory.

Preferably, the present invented embodiment strategically sets the selection relationship between F0 and h as follows:
First, the pulse frequency F0 strictly conforms to its period width T0, and T0 will realize the special provisions of Article 2 below due to a specific setting of h;
Secondly, the sets for T0 should be greater than or equal to h/(1/V0−1/V50), where V0 represents the ultrasonic wave velocity in urea with zero concentration at 4° C., and V50 represents the ultrasonic wave velocity in urea with 50% concentration at 70° C.; the corresponding ultrasonic flight time for V0 and h are denoted as t0, and for V50 and h as t50; the formula T0≥h/(1/V0−1/V50) implies that T0≥(t0−t50), indicating that the application conditions of urea are totally covered within one period width of an ultrasonic pulse;

Third, according to the above article 2, h≤T0 (V0*V50)/(V50−V0), F0*T0=1, then h≤(V0*V50)/((V50−V0)*F0).

The ultrasonic signals will experience three times of signal attenuation on the three contacting surfaces due to the distortion caused by radial aftershocks of piezoelectric ceramic pieces and the generation of a large number of bubbles when the measured urea temperature exceeds or approaches 70° C. By employing a sampling strategy that captures the first wave, there is a high probability (ρ=(Vh/vz)<=2) of signal-to-noise ratio, and even a worse situation may occur (ρ=(Vh/vz)<=1), where Vh represents the signal and vz represents the noise. The system faces an approximate half rate of error triggering or no triggering if amplitude threshold sampling is adopted, leading to potential system crashes. Despite using rising edge zero crossing and combined falling edge zero crossing technology in MS1022 chip to determine the envelope position of the first wave echo signal, there remains the probability for system crashes caused by noise-triggered first waves and signal distortion under extreme background noise fluctuation superposition.

The technical features of the invented embodiment include the dual probe assembly in which one probe is sent and one probe is receive signal.

Firstly, the possibility of distortion of ultrasonic echo signal caused by radial aftershock is avoided.

Secondly, when the measured urea temperature exceeds or approaches 70° C., the ultrasonic signal only faces signal attenuation caused by two times suface bubbles instead of signal attenuation caused by three times surface bubbles.

The third, the high velocity liquid flow formed by the water inlet hole of the cylindrical ring will wash the bubbles away from surfaces generated at high temperature and reduce the amount of bubbles.

In particular, the calibration and decision module, the main control module, and the drive and measurement module, through the communication module, can realize the window opening of the sampling time point tb, and the sampling time point tb can avoid the first echo and choose to randomly trigger sampling in the most stable interval of the entire envelope, during which the influence probability of noise is minimal.

In particular, based on the above characteristics of tb window opening strategy at sampling time point tb, the double probe structure of the invention uses a single probe couple with a reflector structure, which is also an effective feature of the invention and slightly superior in cost, even if the effective probability is weakened a little.

Specifically, the sampling time point tb window opening strategy corresponds to the number of transmitted pulses N, which forms a functional relationship between the number of pulses N and the diameter, thickness and excitation voltage of the piezoelectric ceramic plate. In particular, N is positive to the thickness and diameter of the ceramic plate, and N is inversely negative to the excitation voltage. The sampling time point tb ∈[t0, t0+C], where C is (N+1)*T0, in microseconds.

Specifically, the functions of sampling time point tb window setting, trigger sampling, system timing, policy judgment, data storage, data frame transferring are described as follows:

The main control module starts the pulse, the MS1022 chip synchronously opens the transmitting channel, synchronously the MS1022 system timing tx starts, the transmitting probe piezoelectric ceramic plate in the dual probe is synchronously excited, the ceramic plate synchronously generates ultrasonic vibration, and the ultrasonic wave synchronously begins to propagate into the urea solution.

When the system timing tx reaches the measurement channel window opening time set by the main control module, that is, the sampling time point tb, the MS1022 measurement channel is waiting to trigger as long as the voltage above the setting value, and then MS1022 samples according to the sampling strategy built in the MCU chip.

Specifically, when the measured signal in the detecting channel meets the built-in conditions of MS1022, the measured signal will be sampled according to the built-in conditions of the chip. The sampling process is set as tr when the first rising edge of the ultrasonic signal is triggered, and td when the first falling edge of the ultrasonic signal is triggered. The rising edge and falling edge of the signal exceed the zero or a certain value set by the program and trigger, td−tr≤T0, T0 is a single cycle time of the pulse signal; System time tx, tr, td are extracted and stored for calibration and decision module later.

In particular, the MS1022 chip can achieve picosecond timing accuracy.

The calibration and decision module contains the ultrasonic time-of-flight (ToF) value tf of different concentration Cu and temperature Tu obtained for a single independent dual probe using the application scenario, dependent on the concentration meter and temperature meter, and the relationship between the three can be expressed by the functional formula tf=f (Cu, Tu). It can also be a two-dimensional table structure or database; When the temperature Tu is determined and tf is determined, Cu can be calculated by looking up the table or by the function.

Specifically, tf relies on the strategy in the calibration and decision module for accurate acquisition, which is described in structural language as follows:
a: if (td−tr)>αT0/2, then tf=tr, else (wait for the next trigger data);
b: if (tf<t50), do tf=tf+T0 until tf≥ t50;
c: else if (tf>t0), do tf=tf-T0 until tf≤ t0;
d: return to the main control module.

Preferably, a is greater than or equal to 0.5 and less than or equal to 1.

### BRIEF DESCRIPTION OF DRAWINGS

FIG. 1 is a explosion diagram of the probe assembly 1, probe assembly 2, control module 3, ultrasonic probe base 4, sensor filter 5, temperature sensor 6. Probe top cover

FIG. 2 is a probe component diagram 11, transmitting transducer 12, probe assembly bracket 13, receiving transducer 14, concentration detection cavity 15, cylindrical ring 16, water inlet hole 17, outlet groove 18, transducer sealing ring 19, outlet groove sealing ring P1, the ultrasonic transmitting surface P2, the ultrasonic receiving surface P3, the transmitting stop limit surface P4, the receiving stop limit surface

FIG. 3 is a cross-section diagram of the probe assembly 31, forward column space 32, horizontal column space 33, probe liquid inlet 34, filter sealing ring

FIG. 4 is a section of the extraction chamber FIG. 61, the suction cavity 62, the probe outlet

FIG. 5 is a control module diagram 21. Power module 22, communication module 23, drive and measurement module 24, AD/DA module 25, calibration and decision module 26, main control module

FIG. 6 is a cross-section diagram of the single transmitting transducer a1, the thickness of the ceramic plate is 2 mm (corresponding frequency 1 MHZ) c1, the distance from the transmitting surface to the receiving surface d1, the piezoelectric ceramic panel e1, the ultrasonic reflection panel.

### DETAILED DESCRIPTION OF THE EMBODIMENTS

The following is a clear and complete description of the technical scheme in the embodiment of the invention in conjunction with the attached drawings.

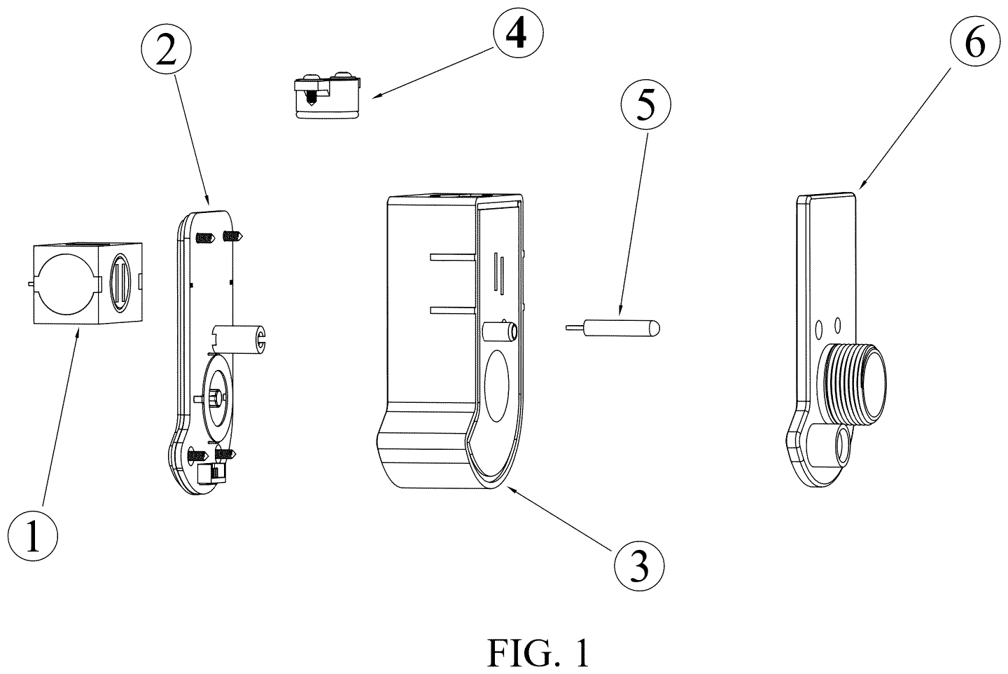

As shown in FIG. 1, an ultrasonic quality sensor based on full concentration coverage within one pulse cycle time, it comprises probe assembly1, control module2, ultrasonic probe base3, probe filter4, temperature sensor5, and probe top cover6.

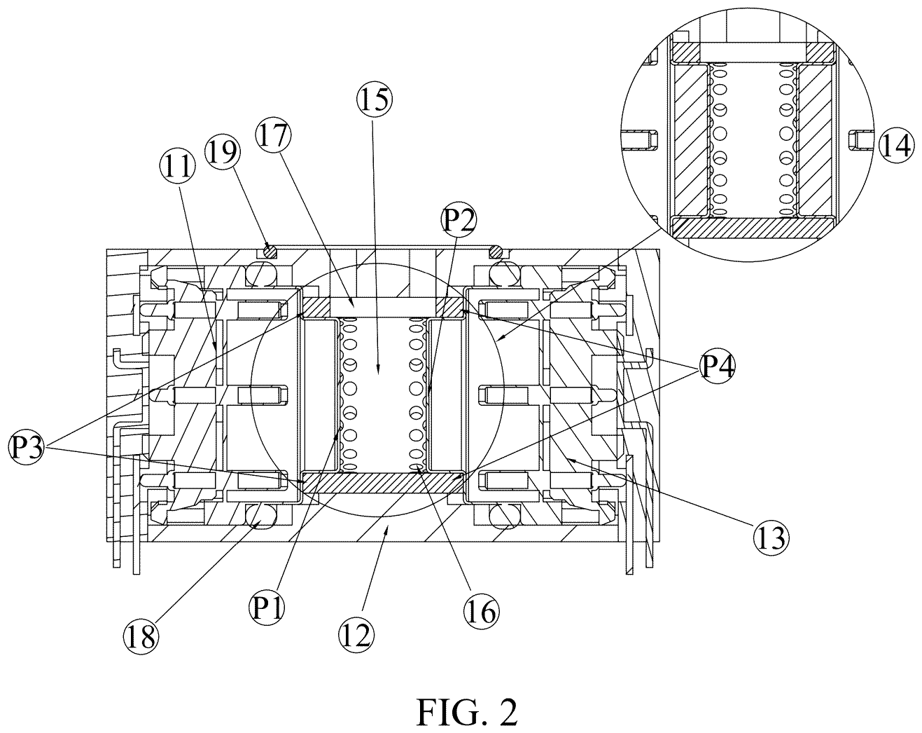

As shown in FIG. 2, the probe assembly 1 consists of two ultrasonic transducers that geometrically form a structural arrangement of facing each other; Two transducers, one transmitting transducer 11 and the other receiving transducer 13.

Preferably, depending on the transmitting and receiving functions, the two transducers have the same thickness and the outer diameters can be inconsistent.

the probe assembly bracket 12 is injection molded with nylon and glass fiber material, the cylindrical ring 15 is pressed into the probe assembly bracket 12 through a tight fitting mode, the transmitting transducer 11 and the receiving transducer 13 are installed into the probe assembly bracket cavity through the transducer sealing ring 18 or sealant; The transmitting stop limit surface P3 of the transmitting transducer 11 and the receiving stop limit surface P4 of the receiving transducer 13 are close to the cylindrical ring 15, and form a structure layout of face to face. The transmitting transducer 11 and the receiving transducer 13 are fixed through the electrode covers at both ends and assembled into the probe assembly 1; Cylindrical ring 15 is made of stainless steel.

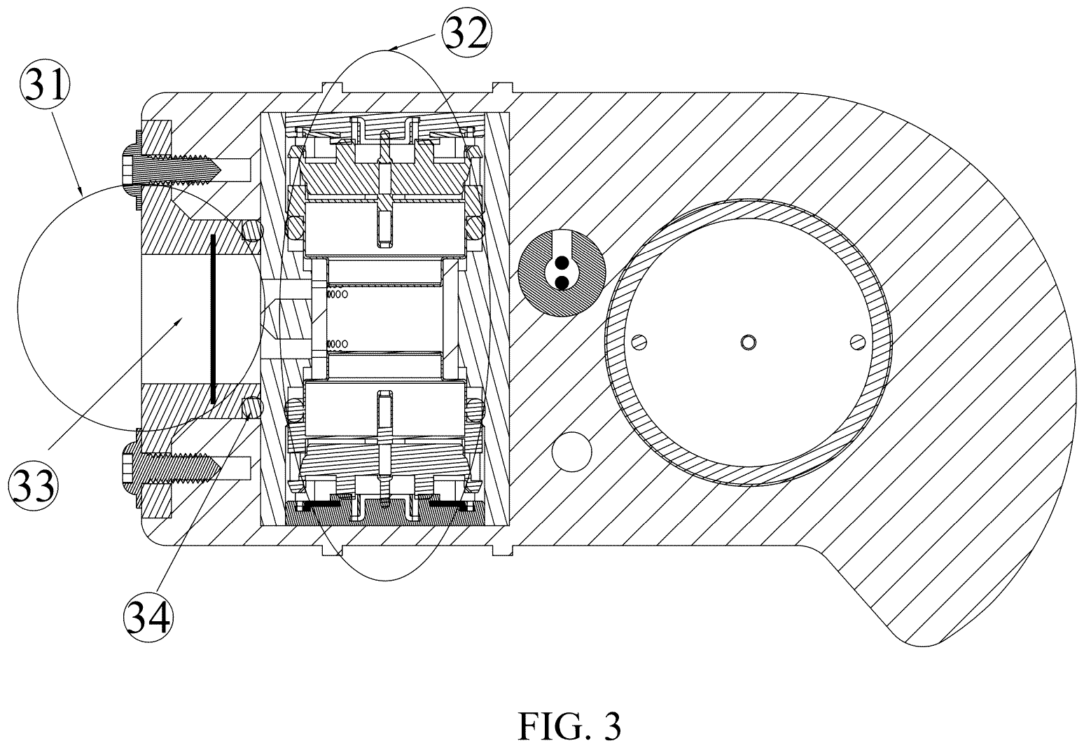

The ultrasonic probe base 3, as shown in FIG. 3, is manufactured using injection molding with engineering plastics and glass fiber materials. The component features a “T” shaped double columnar space, consisting of a forward columnar space and a horizontal columnar space perpendicular to the forward one. The columnar spaces can be either cylindrical or quadrilateral.

The horizontal columnar space 32 is designed for mounting the probe assembly 1. First, place the outlet groove sealing ring 19 on the outlet groove 17 of the probe assembly 1, then insert the probe assembly into the horizontal columnar space 32.

The probe liquid inlet 33 is equipped with a filter sealing ring 34 to ensure sealing and a probe filter 4 for filtration; the probe filter is secured in the forward column space31 of the ultrasonic probe base by screws.

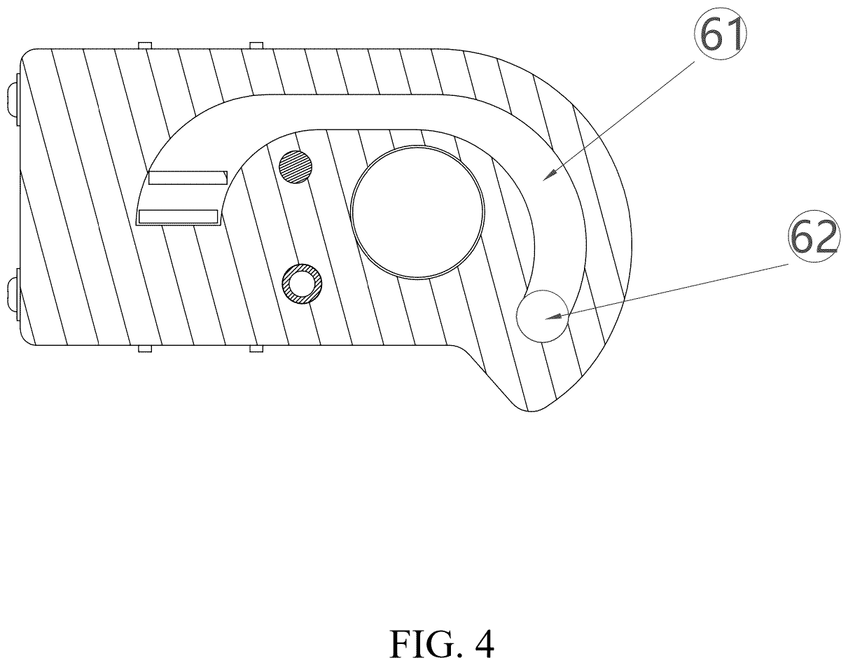

As depicted in FIG. 4, the probe top cover is produced through injection molding with engineering plastics and glass fiber materials. The ultrasonic hot melting process fuses together the probe top cover6 and ultrasonic probe base to form a sealed suction cavity61.

At the tail end of the suction cavity61 of the probe top cover6 lies its probe outlet 62 with a connecting pipe, which is sealed at SCR system's suction tube inlet by a sealing ring. This forms an enclosed space when connected with the suction cavity 61 of the probe top cover.

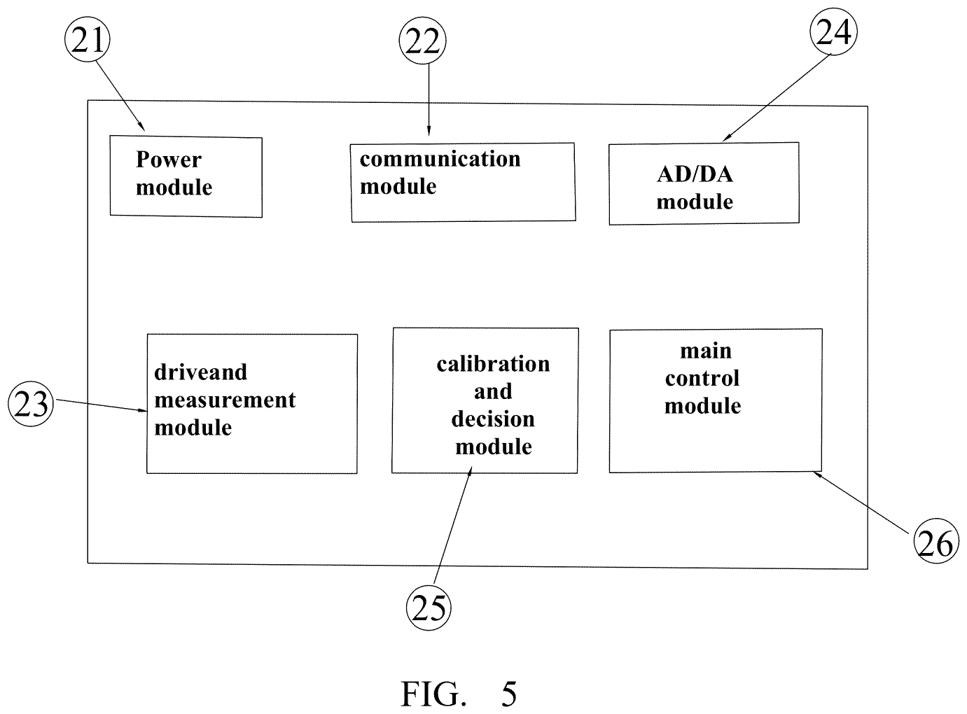

The control module 2, as depicted in FIG. 5, incorporates a power module 21, a communication module 22, a drive and measurement module 23, an AD/DA module 24, a calibration and decision module 25, and a main control module 26. The hardware PCBA for this integration is commercially sourced through outsourced procurement.

The realization of the one pulse cycle time covering full concentration urea solution depends on the parameter selection of pulse frequency F0, ultrasonic wave flight distance h in detecting urea solution, ultrasonic wave flight speed V0 at low temperature (4° C.) with zero concentration, and ultrasonic wave flight speed V50 at high temperature (70° C.) with 50% urea concentration solution.

Strategically setting V0 and V50 values ensures accuracy: the software sets V0 slightly lower than actual measured value while setting V50 slightly higher.

High-precision ultrasonic velocity meter is utilized to obtain ultrasonic velocities: V0 at low temperature (4° C.) with 0% urea solution and V50 at high temperature (70° C.) with 50% urea solution. Data processing involved obtaining average values from multiple measurements.

Preferably, it is recommended to use the average value from ten measurements.

The average ultrasonic velocities obtained by velocity meter are as follows:
V0 is 1422 m/s, and
V50 is 1705 m/s.

Following strategic arrangement guidelines mentioned earlier results in setting V0 to be at1400 m/s and V50 to be at 1720 m/s.

### Example

The pulse frequency F0 generated by the main control module 26 is 1 MHz. According to the frequency characteristics of the piezoelectric ceramic plate d1, the geometric specifications of the transducer plate in the transmitting transducer 11 and the receiving transducer 13 corresponding to a frequency of 1 MHz are determined to be 2 mm.

The preferred piezoelectric ceramic plate d1 is a disk with a diameter of 10 mm, and its driving voltage is set at a direct output voltage of 3.3V from the chip.

Optimal determination of the number of pulses N in the master program involves using a driver for continuously adjusting pulse square waves and reading amplitude when peak saturation is reached on the ceramic chip of the receiving transducer with an oscilloscope.

The optimal value for pulse number N is obtained when exceeding a certain number results in no further increase in amplitude.

In particular, as long as it satisfies system stability requirements, any positive integer greater than or equal to 3 can be selected for N according to this invention.

Setting of the ultrasonic flight distance h parameter in the main control module:

h≤(V0*V50)/((V50−V0)*F0), V50, V0 and F0 are 1720 m/s, 1400 m/s and 1 MHz respectively, and the maximum allowable value for h is 7.53 mm, and in order to avoid the need for high processing and assembly accuracy of dual probe components, it is often chosen to be close to this maximum value, with 7.5 mm being the optimal choice according to the invention. Other values of h that comply with above the specified formula are also acceptable but less preferable

Realization of the sampling time point tb parameter in main control module:
tb∈[t0, t0+C], where C is (N+1)*T0; from the above h is the best choice 7.5 mm, N is the best choice 5, V0=1400 m/S, t0=5.36 μS, then 11.36 μS≥tb≥5.36 μS.

The value of tb can be achieved by random function in the range of 5.36 to 11.36 uS, including 5.36 or 11.36 uS.

t0 and t50 based on h, V0 and V50 are clearly defined, these can be determined according to the following formula:

t0=h/V0, t50=h/V50.

Setting of cylinder ring length L size in probe assembly:

Because the thickness of the piezoelectric ceramic plate d1 of the ultrasonic probe is 2 mm, when H≤2 mm, the upper surface of the piezoelectric ceramic plate d1 in the inner liner of the ultrasonic probe can be guaranteed to exceed the inner liner a round step, so that the piezoelectric ceramic plate d1 is pressed by the wave absorbing glue. L=h+2 Hmm≤13 mm, in this embodiment, H is 7.5 mm, H is 1.8 mm, then L is 11.1 mm.

The technical characteristics of the invention provide the following decision strategies for accurate tf in calibration and decision module 25:
a: if (td−tr)>αT0/2, then tf=tr, else wait for the next trigger sampling;
b: if (tf<t50), do tf=tf+T0 until tf≥t50;
c: else if (tf>t0), do tf=tf−T0 until tf≤t0;
d: return to the main control program

In the illustration of the above embodiments, the design or implementation method for the parameters T0, t0 and t50 involved in the tf decision strategy has been completed. However, accurate determination of tf also depends on three other parameters: tr, td and α.

td and tr are controlled by the main control module 26, and the MS1022 chip's measurement channel detecting function is activated through drive and measurement module 23. The MS1022 chip can initiate signal sampling at sampling time point tb; its specific action flow for sampling involves determining the first rising edge trigger time tr and first falling edge trigger time td based on previous tb timing.

The starting point of the first wave of ultrasonic signal can be calculated based on tr and tf using a decision strategy within the control module.

α is closely related to ultrasonic signal intensity and noise level. When signal-to-noise ratio is weak, α should be close to 0.5; when it is strong, a can approach 1.

At this stage, the capability to obtain precise time of flight (TOF) is well-established, and the subsequent procedure is referred to as the probe and system calibration process.

During the calibration process, a two-dimensional relation table can be derived for multiple temperature segments using the linear segmental calibration method, while an accurate functional relation across the entire temperature measurement range can be obtained through high-order function fitting curve methodology. These two technologies represent highly mature advancements within the realm of information technology.

### Example

Technical characteristics based on one of the core of the invention: The three parameters of ultrasonic flight distance h, excitation pulse number N and free fixed point time tb are strictly related to the thickness and diameter of piezoelectric ceramic plate d1, the frequency of excitation pulse F0, and the flight velocity V0 and V50 of ultrasonic wave at low temperature 4° C. and 0% urea solution and high temperature 70° C. and 50% urea solution.

This technical feature guarantees the advantages of ultrasonic real time of flight tf:
first, it will not exceed the urea concentration range;

Second, under the same hardware conditions, the sampling time point tb guarantees the optimal SNR at the sampling time, and the tf accuracy is less affected.

The integration of both transmitting and receiving functions within a single transducer structure, which meets the required technical characteristics, can be considered as an effective embodiment of the invention through corresponding design. This integration also falls within the scope that requires protection, specifically as outlined below:

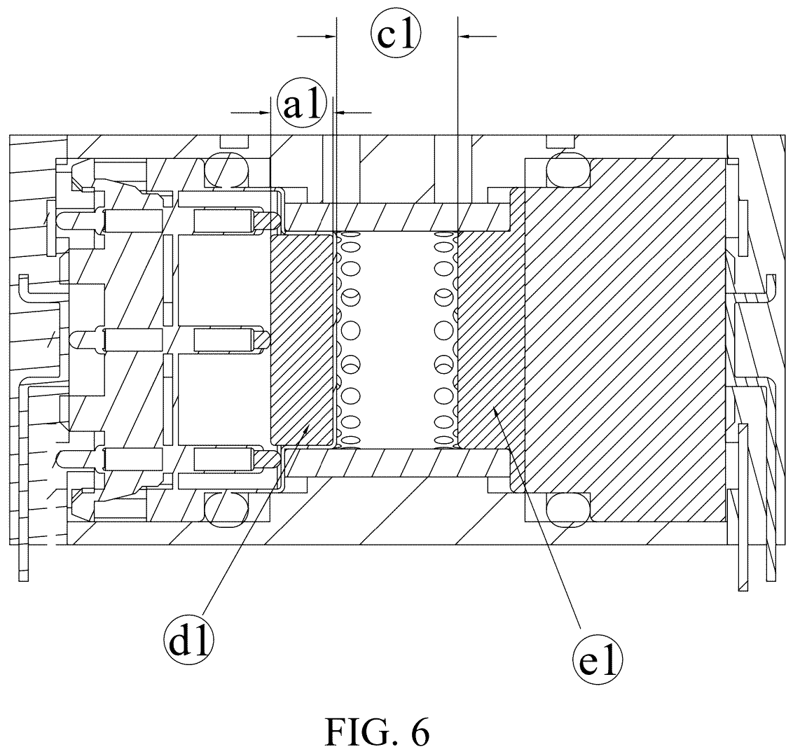

As shown in FIG. 6, the dual probe assembly 1 may also adopt a reflection structure opposite a single transmitting transducer 11 and an ultrasonic reflection panel e1.

Preferably, the piezoelectric ceramic plate d1 is a disk, the thickness is 2 mm, the diameter is 10 mm, the excitation pulse frequency F0 is 1 MHz, and the flight distance h is less than or equal to 7.5 mm.

In particular, unlike the sensor probe with double probe structure, the distance from the ultrasonic transmitting surface to the reflecting surface of the single probe is half h, which means c1-h/2=3.75 mm.

Preferred, the ultrasonic reflector panel e1 is made of stainless steel by stamping, and the ultrasonic reflector is ground and polished so that its roughness is ≤0.2 μm.

The invention specifically focuses on elucidating the interdependence between the design parameters “flight distance h, actuating pulse number N, and sampling time point tb” with the thickness and diameter of the piezoelectric ceramic plate d1, the frequency of the actuating pulse F0, and the ultrasonic wave velocity. The technical characteristics of flight velocities V0 and V50 are defined as ultrasonic wave velocity in 0% urea solution at 4° C. and in 50% urea solution at 70° C.

In this embodiment, preferred values for h=7.5 mm, N=5 and a range of tb from 5.36 μs to 11.36 μS correspond to a thickness of 2 mm for the piezoelectric ceramic disk d1.

The selection of a diameter of 10 mm, an actuating pulse frequency of 1 MHz, and specific values for V0 (1400 m/s) and V50 (1720 m/s) represent special cases that adhere to the aforementioned technical characteristics.

Other parameter selections such as F0=500 kHz or F0=2 MHz result in correlated values for h, N, tb, and thickness derived according to the technical characteristics of this invention are as followings:
h is less than or equal to 15.05 mm or greater than or equal to 3.76 mm, N is either 10 or 3,
tb ranges from 32.75 μs down to 10.75 μS or from 4.69 μs up to 2.69 μS, ceramic disk d1 has a thickness of either 4 mm and 1 mm.

The optimal choice of diameter depends on the determined thickness of the piezoelectric ceramic disk d1.

All other embodiments obtained by ordinary skilled personnel in this field without involving creative effort fall within the scope of protection provided by this invention.

What is claimed is:

1. An ultrasonic quality sensor comprising:
a probe assembly1,
a control module2
an ultrasonic probe base3,
a probe filter4,
a temperature sensor5, and
a probe top cover 6;
the probe assembly 1 is is composed of two ultrasonic transducers geometrically shaped into a structural layout of facing each other; Two transducers, one is a transmitting transducer 11, the other is a receiving transducer 13, and the transducer is connected by a probe assembly bracket 12; the probe assembly bracket 12, the transmitting transducer11 and the receiving transducer 13 constitute the concentration detection cavity 14 of the quality sensor; the concentration detection cavity 14 is a cavity formed by a regular quadrangular cylindrical solid body hollowed out the central axis of the cylindrical body, the cavity is cylindrical, the two ends of the cylinder are respectively placed in a receiving transducer 13 and a transmitting transducer 11, and a cylindrical ring 15 is placed on between the two transducers touching the side wall of cavity; the cylindrical ring 15 is equipped with multiple forward water inlet holes 16 in the horizontal direction, a outlet groove 17 in the vertical direction;
the ultrasonic probe base 3 is equipped with a “T” shaped double column space, where a horizontal column space 32 perpendicular to a forward column space31 are utilized for arranging the probe assembly 1; one end of the forward column space 31 is connected to the forward water inlet hole 16 of a cylindrical ring 15 in the probe assembly 1, while the other end serves as a probe liquid inlet33;
the horizontal column space 32is designed to accommodate the probe assembly 1, which includes a cylindrical ring 15 with a outlet groove17 connected to the suction cavity 61 of the probe top cover6 through a sealing ring, forming a sealed space;
the probe liquid inlet 33 is equipped with a probe filter, filter sealing ring 34 to create a sealing effect that enables the filtering of urea during suction;
the probe outletr62 is located at the end of the suction cavity 61 within the probe top cover (6), and It is sealed by a sealing ring in between the inlet suction tube of the SCR system, and forms an enclosed space when connected to the suction cavity 61of the top cover.

2. The ultrasonic quality sensor of claim 1, wherein the cylindrical ring 15 is made of metallic stainless steel, and its length L is less than or equal to h+2 Hmm; the two ends of the cylinder ring15 are in surface contact with the transmitting transducer 11 at its stop surface P3, as well as with the receiving stop limit surface P4 of the receiving transducer 13; the two end faces of the cylinder ring 15 are strictly perpendicular to the axis of the cylinder ring 15, and the end faces are highlight surfaces; H is the distance from the transmitting surface P1 to the transmitting stop limit surface P3 or the receiving surfaceP2 to the receiving stop limit surface P4; the assembly relationship between the cylindrical ring 15 and the two transducers ensures that the position relationship between the ultrasonic transmitting surface P1 and the ultrasonic receiving surface P2 of the transmitting transducer11 and the receiving transducer13 is vertical and coaxial, with a distance h between them; the area of the outlet groove 17 of the cylindrical ring15 significantly exceeds the combined area of the forward inlet hole 16, which represents the narrowest section within the entire cavity of the suction cavity from the probe liquid inlet33 to the SCR system; the liquid inflow direction from the cylindrical ring 15into the inlet hole 16is nearly tangent to both the ultrasonic transmitting surfaceP1 and ultrasonic receiving surface P2 of both transmitting transducer 11and receiving transducer 13.

3. The ultrasonic quality sensor of claim 1, wherein The control module 2 consists of a power module21, a communication module 22, a drive and measurement module 23, an AD/DA module 24, a calibration and decision module 25, and a main control module 26; the power module21 provides power to the whole control module; the communication module 22 is based on the SAE1939 communication protocol connecting quality sensor with the host computer of SCR system;
the control module 2 is equipped with a temperature sensor 5 for measuring the urea temperature and its corresponding electronic circuit; the temperature measurement data of the urea solution are utilized in establishing the calibration and decision function or database of calibration and decision module 25;
the drive and measurement module 23 selects the core chip MS1022 or its updated iteration, which features a dual-channel independent operation function, this includes a transmitting channel and a measuring channel, corresponding to the probe transmitting transducer 11 and receiving transducer 13;
the main control module 26 regulates the generation of a fixed frequency square wave, denoted as F0, which is then applied to the transmitting transducer 11; the two poles of the transducer plate produce ultrasonic waves that travel a fixed distance h before reaching the receiving transducer;
the fixed frequency F0 has a selection relation with the flight distance h, and the selection relation is as follows:
First, the pulse frequency F0 strictly conforms to its period width T0, and T0 will realize the special provisions of Article 2 below due to a specific setting of h;
Secondly, the sets for T0 should be greater than or equal to h/(1/V0−1/V50), where V0 represents the ultrasonic wave velocity in urea with zero concentration at 4° C., and V50 represents the ultrasonic wave velocity in urea with 50% concentration at 70° C.;
the corresponding ultrasonic flight time for V0 and h are denoted as t0, and for V50 and h as t50; the formula T0>h/(1/V0−1/V50) implies that T0> (t0-t50), indicating that the application conditions of urea are totally covered within one period width of an ultrasonic pulse;
Third, according to the above article 2, h≤T0 (V0*V50)/(V50−V0), F0*T0=1, then h≤(V0*V50)/((V50−V0)*F0).

4. The ultrasonic quality sensor of claim 3, wherein The communication module22 coordinates the calibration and decision module 25, the main control module26, and the drive and measuring module 23to initiate the measurement window at a predetermined sampling time point tb;
the sampling time point tb for opening the measurement window in the free time strategy is determined by the number of transmitted pulses N; this number of pulses N is functionally related to the diameter, thickness, and excitation voltage of the piezoelectric ceramic plated1, being directly proportional to the thickness and diameter of the ceramic plate and inversely proportional to the excitation voltage; the sampling time point tb∈[t0, t0+C], where C is (N+1)*T0, in microseconds.

5. The ultrasonic quality sensor of claim 3, wherein the calibration and decision module 25 includes the time-of-flight ToF value tf for a single independent probe assembly, simulating the real operation scenario of the automobile, relying on the concentration meter and temperature meter to obtain ultrasonic flying time under different concentration Cu and different temperature Tu;
the relationship among the three elements can be represented by the function relation tf=f (Cu, Tu), or it can take the form of a two-dimensional relational table structure; the specific value of tf also depends on the policy setting in the calibration and decision module (25); the detailed strategy is articulated in structured language as follows:
a: if (td−tr)>αT0/2, then tf=tr, else wait for the next trigger sampling;
b: if (tf<t50), do tf=tf+T0 until tf≥t50;
c: else if (tf>t0), do tf=tf−T0 until tf≤ t0;
d: return to the main control.

6. The ultrasonic quality sensor of claim 5, wherein the parameter a commits to: 1≥α≥1/2.
